(19) United States
(12) Patent Application Publication
(10) Pub. No.: US 2008/0100869 A1
(43) Pub. Date: May 1, 2008

(54) Information Processing Device and Printer Driver

(75) Inventor: Takashi NAGAI, Shiojiri-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 11/864,511

(22) Filed: Sep. 28, 2007

(30) Foreign Application Priority Data
Oct. 30, 2006 (JP) 2006-293556

(51) Int. Cl. G06K 15/00

(52) U.S. Cl. 358/1.18

(57) ABSTRACT

An information processing device provided with a direct printing function that causes a printer device to execute printing without a printer driver, comprising: a setup storage unit that stores a combination of set values (direct printing setup data) relating to a plurality of printing setting items (direct setting items) in association with a specific folder or file (hot folder, or the like); a setup registration unit that creates direct printing setup data based on a hot folder or the like selected by a user and registers that direct printing setup data in the setup storage unit; and a unit that generates, when a printing target file has been dragged and dropped to a hot folder or the like, printing data based on the printing target file and the direct printing setup data associated with the hot folder or the like, and transmits the generated printing data to the predetermined printing device, wherein the setup registration unit includes: an acquisition unit that acquires a combination of preset values relating to a plurality of printing setting items created by the printer driver (preset printing setup data); and a unit that extracts set values corresponding to the direct setting items from the acquired preset printing setup data to create direct printing setup data.

### BACKGROUND

1. Technical Field

The present invention relates to an information processing technology for carrying out printing setup of a printer device and the like, and more particularly, to a preferable information processing technology in the case of registering a combination of set values relating to a plurality of printing setting items and using that combination to carry out printing.

2. Related Art

In the past, in the case of carrying out printing with a printer device, printing was typically carried out by being accessed a printer driver from an application operating on a host device, and executing printing setup and generation and transmission of printing data for the printer device via the printer driver.

More recently, printer drivers have been proposed and developed that are provided with a preset printing function enabling printing to be carried out easily by pre-registering a combination of set values relating to a plurality of printing setting items, displaying an icon corresponding to that combination, and carrying out printer setup en bloc for a plurality of printer setting items by clicking on the icon (see JP-A-2002-182871).

On the other hand, application software (direct printing tool) is also known that enables document and other files created using an application to be printed directly without having to boot the application or go through a printer driver. For example, JP-A-2001-296980 discloses a configuration in which a hot folder associated with a preset printing setting file is created, and printing is executed based on the associated preset printing setting file and a dropped document or other file in the case of having dragged and dropped the document or other file to the hot folder.

### SUMMARY

Since a direct printing tool of the prior art is designed for the purpose of executing printing without a printer driver, there are many cases in which there are no considerations given to linking with the printer driver.

The inventors of the present invention noticed that the direct printing function not requiring a printer driver and the preset printing function provided with a printer driver share the common feature of executing printing by using a pre-registered printing setup, and realized that user convenience could be greatly improved if it were possible to mutually use printing setup information between both functions.

Therefore, an object of the present invention is to provide a new scheme capable of carrying out direct printing setup using preset printing information in a printer driver, or carrying out preset setup in a printer driver by using direct printing information.

The information processing device of the present invention is an information processing device provided with a direct printing function that causes a printer device to execute printing without a printer driver, comprising: a setup storage unit that stores a combination of set values (direct printing setup data) relating to a plurality of printing setting items (direct setting items) in association with a specific folder or file (hot folder, or the like) a setup registration unit that creates direct printing setup data based on a hot folder or the like selected by a user and registers that direct printing setup data in the setup storage unit; and a unit that generates, when a printing target file has been dragged and dropped to a hot folder or the like, printing data based on the printing target file and the direct printing setup data associated with the hot folder or the like, and transmits the generated printing data to the predetermined printing device, wherein the setup registration unit includes: an acquisition unit that acquires a combination of set values relating to a plurality of printing setting items created by the printer driver (preset printing setup data); and a unit that extracts set values corresponding to the direct setting items from the acquired preset printing setup data to create direct printing setup data.

According to this configuration, direct printing setup can be carried out by using preset printing information in a printer driver, thereby making it possible to greatly improve user convenience with respect to printing setup.

Preferably, the acquisition unit of the information processing device displays the name or the like of preset printing setup data corresponding to the printer device for each printer device to which the information processing device is capable of transmitting printing data, and acquires preset printing setup data selected by a user who refers to the display.

The printer driver of the present invention is a printer driver provided with a preset printing setup function for pre-registering a combination of set values (preset printing setup data) relating to a plurality of printing setting items (preset setting items), and carrying out printing setup en bloc for the plurality of printing setting items based on the preset printing setup data, comprising: a preset storage unit that stores the preset printing setup data in association with a preset symbol for selecting the preset printing setup data, and a preset registration unit that creates the preset printing setup data for a predetermined preset symbol and registers that preset printing setup data in the preset storage unit, wherein the preset registration unit includes: an acquisition unit that acquires a combination of set values relating to a plurality of printing setting items (direct printing setup data) created by an information processing device that causes the printer device to execute printing without a printer driver; and a unit that extracts set values corresponding to the preset setting items from the acquired direct printing setup data to create preset printing setup data.

According to this configuration, preset setup can be carried out in a printer driver by using direct printing information, thereby making it possible to greatly improve user convenience with respect to printing setup.

Preferably, the acquisition unit acquires the direct printing setup data stored by the information processing device in association with a specific folder or file in the case an icon of the specific folder or file has been dragged and dropped to a predetermined window.

The direct printing method of the present invention is a direct printing method that causes printing to be executed on a printer device without a printer driver, the method comprising: creating a combination of set values (direct printing setup data) relating to a plurality of printing setting items (direct setting items), and storing the direct printing setup data in association with a specific folder or file (hot folder or the like) selected by a user; and generating, when a printing target file has been dragged and dropped to a hot folder or the like, printing data based on the dropped printed target file and the direct printing setup data associated with the hot folder, and transmitting the generated printing data to the predetermined printing device, wherein the creating step includes: acquiring a combination of set values relating to a plurality of printing setting items created by the printer driver (preset printing setup data); and extracting set values corresponding to the direct setting items from the acquired preset printing setup data to create direct printing setup data.

The preset printing setup method of the present invention is a preset printing setup method utilizing a printer driver, the method comprising: creating, by the printer driver, a combination of set values (preset printing setup data) relating to a plurality of printing setting items (preset setting items) and storing the preset printing setup data in a storage unit; and carrying out, by the printer driver, printing setup en bloc for the plurality of preset setting items based on the preset printing setup data, wherein the creating step includes: acquiring, by the printer driver, a combination of set values relating to a plurality of printing setting items (direct printing setup data) created by an information processing device that causes a printer device to execute printing without the printer driver, and extracting, by the printer driver, set values corresponding to the preset setting items from the acquired direct printing setup data to create preset printing setup data.

The direct printing method and preset printing setup method of the present invention can be executed by an information processing device (computer), and the programs for those methods can be installed or loaded through various media such as a CD-ROM, magnetic disk, semiconductor memory or communication network.

According to the present invention, a new scheme can be provided capable of carrying out direct printing setup by using preset printing information in a printer driver, or carrying out preset setup in a printer driver by using direct printing information.

### BRIEF DESCRIPTION OF THE DRAWINGS

FIG. 1 is a block diagram showing the configuration of a printer system 1 in an embodiment of the present invention;

FIG. 2 is a block diagram showing the function configuration of a host device 10;

FIG. 3 is a drawing showing an example of the data configuration of a printing setup management information storage unit 32;

FIG. 4 is a drawing showing an example of the data configuration of a preset printing setup data storage unit 33;

FIG. 5 is a drawing showing an example of the data configuration of a printing setup management information storage unit 50;

FIG. 6 is a drawing showing an example of the data configuration of a direct printing setup data storage unit 51;

FIG. 7 is a block diagram showing the function configuration of a printer device 20;

FIG. 8 is a flow chart showing the procedure in the case of printing through a printer driver unit 13;

FIG. 9 is a flow chart showing the procedure in the case of printing through a printer driver unit 13;

FIG. 10 is a flow chart showing the procedure in the case of printing through a printer driver unit 13;

FIG. 11 is flow chart showing the procedure in the case of printing through a printer driver unit 13;

FIG. 12 is a flow chart showing the procedure in the case of printing with a direct printing unit 14;

FIG. 13 is a flow chart showing the procedure in the case of printing with a direct printing unit 14;

FIG. 14 is a flow chart showing the procedure in the case of printing with a direct printing unit 14;

FIG. 15 is a flow chart showing the procedure in the case of printing with a direct printing unit 14;

FIG. 16 is a flow chart showing the procedure in the case of printing with a direct printing unit 14;

FIG. 17 is a drawing showing an example of the display of a preset base printing setup window 100;

FIG. 18 is a drawing showing an example of the display of a preset printing setup data editing window 200;

FIG. 19 is a drawing showing an example of the display of a direct printing setup window 300; and

FIG. 20 is a drawing showing an example of the display of a direct printing setup data editing window 400.

### DESCRIPTION OF EXEMPLARY EMBODIMENTS

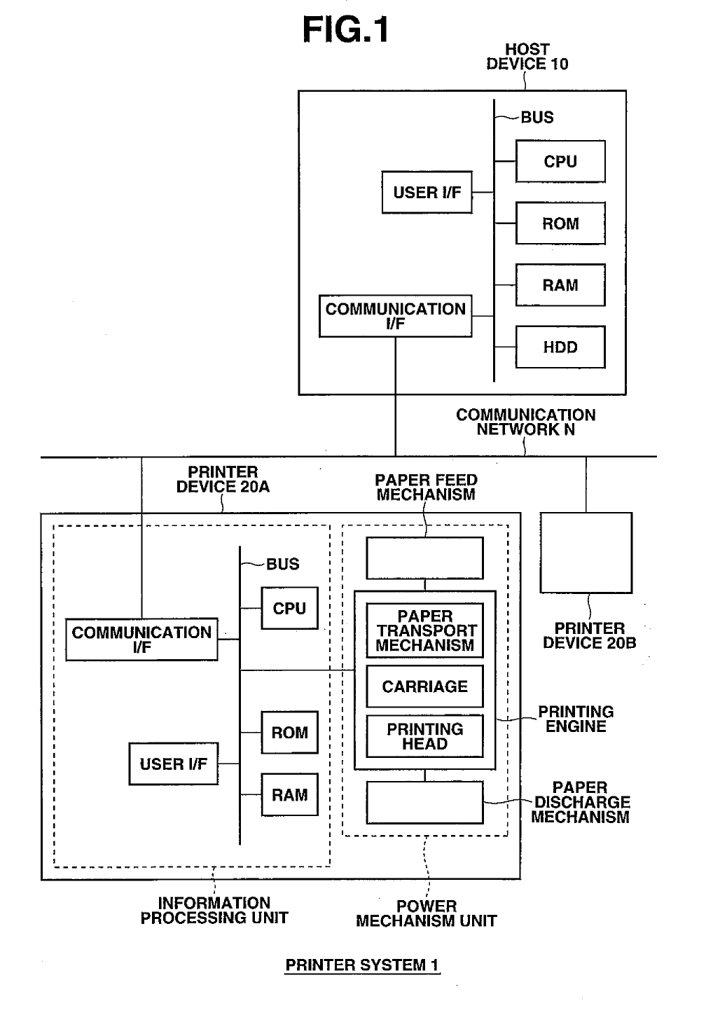

FIG. 1 is a block diagram showing the hardware configuration of a printer system 1 in an embodiment of the present invention. As shown in FIG. 1, the printer system 1 comprises a host device 10 and printer devices (image forming devices) 20A and 20B which can communicate with the host device 10 through a communication network N (LAN, Internet, dedicated line, packet communication network, USB or other device connection interface or any combination thereof; either or both wired and wireless forms can be adopted).

Furthermore, since the functional configurations of the printer devices 20A and 20B are the same in principle, unless specifically necessary to distinguish between the two, printer devices 20A and 20B will be collectively referred to as printer device 20.

(Host Device)

The host device 10 is provided with hardware such as a CPU, ROM, RAM, user interface, communication interface and HDD, and the CPU is able to access each component through a bus (see FIG. 1).

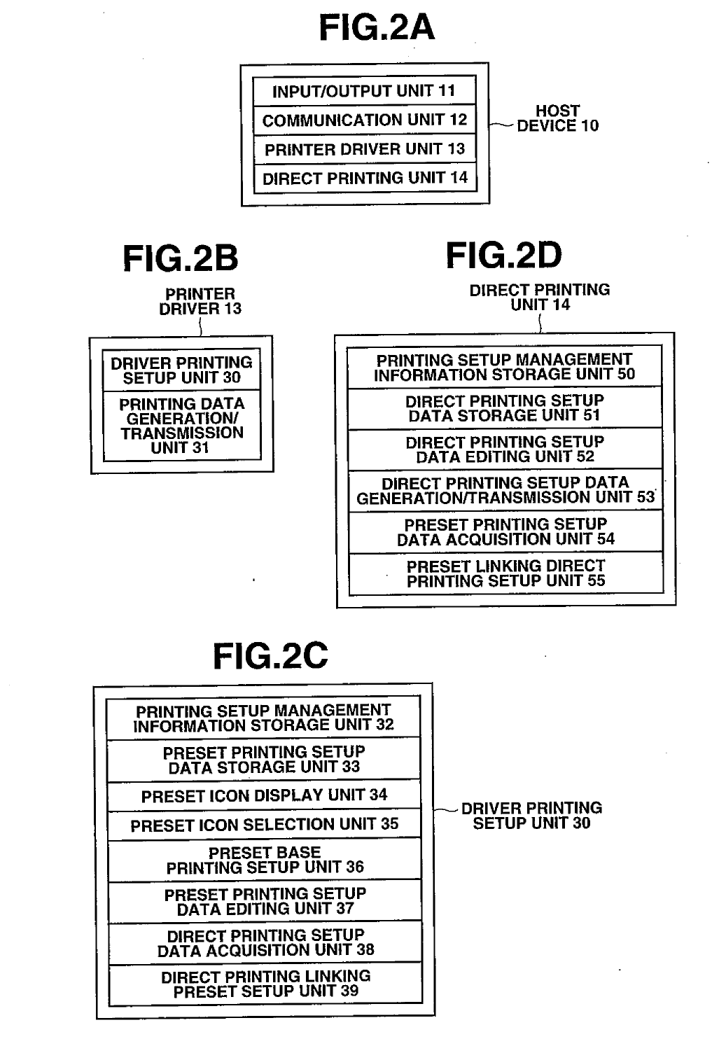

The host device 10 provides functions similar to those of an information processing device such as an ordinary personal computer. For example, the host device 10 is provided with an input/output unit 11 for receiving various inputs from a keyboard and the like or outputting information to a display and the like through the user interface, a communication unit 12 for sending and receiving various data to and from other devices through the communication interface, and printer driver unit 13 for controlling a printer, and a direct printing unit 14 capable of printing directly without a printer driver (see FIG. 2).

The printer driver unit 13 and the direct printing unit 14 are provided with the same function configuration as a printer driver and direct printing tool of the prior art.

For example, the printer driver unit 13 is provided with a driver printing setup unit 30 for carryout out printing setup in the case of printing with the printer device 20 through the printer driver unit 13, and a printing data generation/transmission unit 31 for generating printing data described by a predetermined printer control language such as Postscript based on the printing setup, and transmitting the printing data to the printer device 20 to cause the printer device 20 to execute printing (see FIG. 2B).

The driver printing setup unit 30 is provided with the pre-set printing function (preset system) capable of pre-registering a combination of set values relating to a plurality of printing setting items as preset printing setup data, displaying an icon corresponding to the preset printing setup data, and carrying out printing setup en bloc for the plurality of printing setting items by clicking the icon. In order to accomplish this, the driver printing setup unit 30 is provided with, for example, a printing setup management information storage unit 32, a preset printing setup data storage unit 33, a preset icon display unit 34, a preset icon selection unit 35, a preset base printing setup unit 36, and a preset printing setup data editing unit 37 (see FIG. 2C).

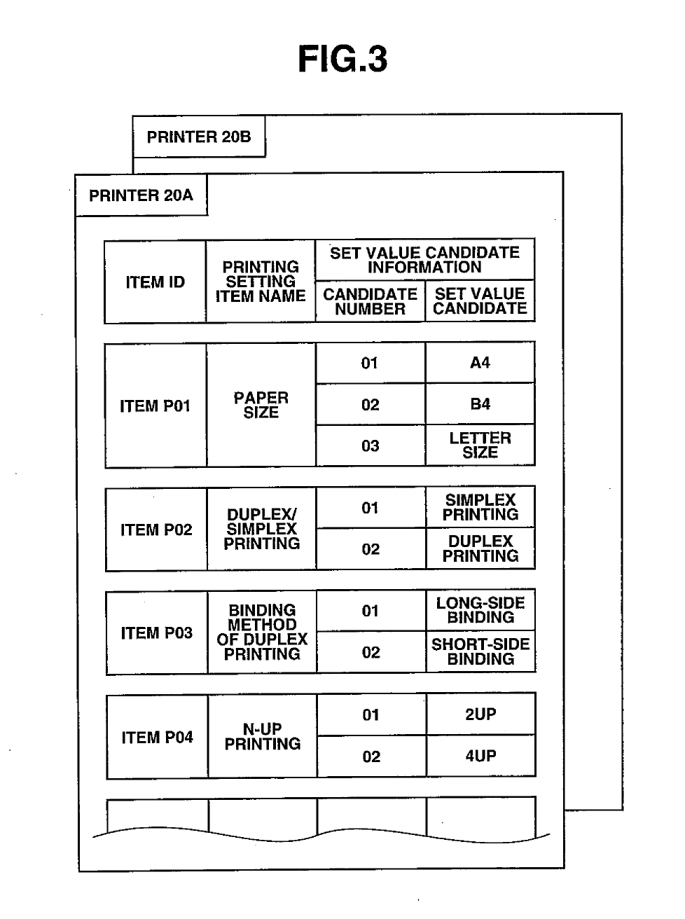

The printing setup management information storage unit 32 stores information of values designatable as set values (set value candidates) for each of the plurality of printing setting items (preset setting items) referred to when carrying out printing setup with the preset system for each printer device 20 (see FIG. 3). Examples of preset setting items include paper type, number of printouts, paper size, printing resolution, designation of duplex or simplex printing, binding method of duplex printing and up number of N-up printing, and various setting items are possible corresponding to the design. In addition, as shown in FIG. 3, item IDs are assigned to the preset setting items and candidate numbers are assigned to the set value candidates for management in the present embodiment, resulting in a configuration that enables the set value of each preset setting item to be specified by designating a item ID and candidate number.

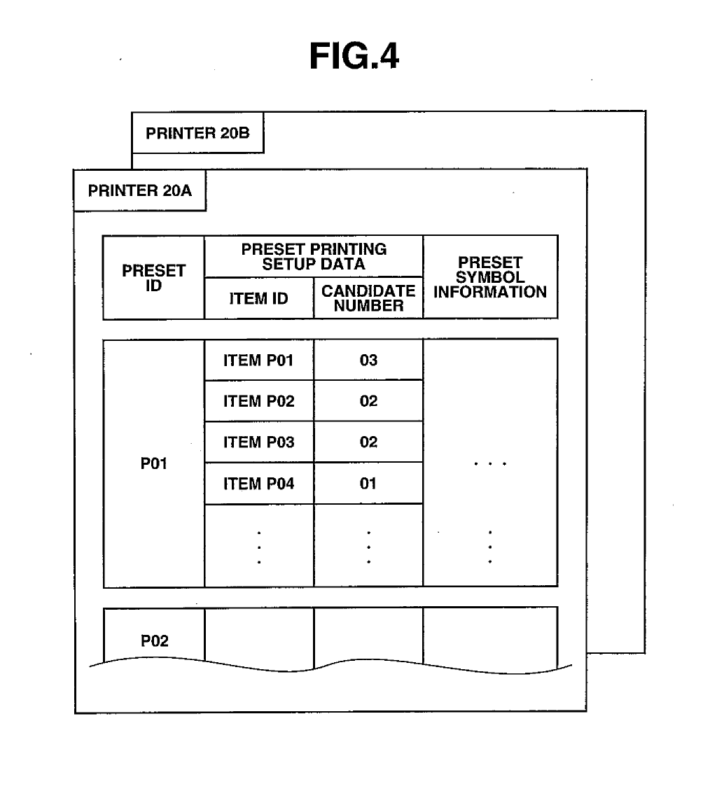

The preset printing setup data storage unit 33 stores combinations of set values relating to a plurality of preset setting items (preset printing setup data) and corresponding preset symbol information for selecting the preset printing setup data for each printer device 20 (see FIG. 4). The preset symbol information can contain, for example, icon image information and preset printing setup data names.

Since the operation of the other units 34 to 37 is the same as that of the prior art in principle, these operations are described in detail in an explanation of printing operation to be described later.

On the other hand, the direct printing unit 14 is provided with, for example, a printing setup management information storage unit 50, a direct printing setup data storage unit 51, a direct printing setup data editing unit 52 and a direct printing data generation/transmission unit 53 in order to realize a direct printing function by which the printer device 20 is caused to execute printing without the printer driver unit 13 based on a printing target file dragged and dropped to a specific folder or file (such as a hot folder) (see FIG. 2D).

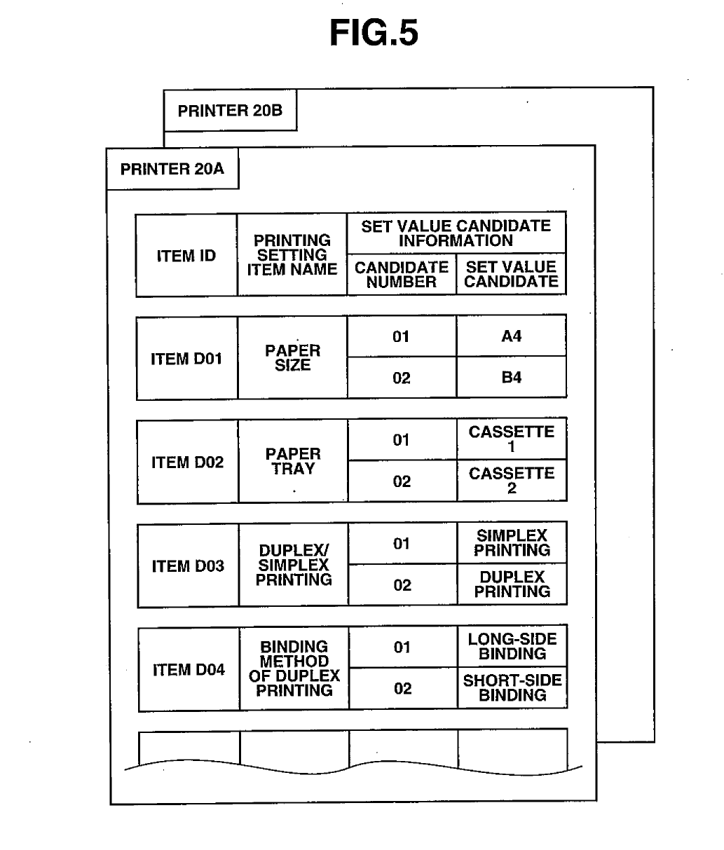

The printing setup management information storage unit 50 of the direct printing unit 14 stores information of values designatable as set values (set value candidates) for each of the plurality of printing setting items (direct setting items) referred to when carrying out direct printing for each printer device 20 (see FIG. 5). As shown in the FIG. 5, although the printing setup management information storage unit 50 of the direct printing unit 14 in the present embodiment employs the same data configuration as the printing setup management information storage unit 32 of the driver printing setup unit 30, direct setting items and preset setting items are not necessarily required to coincide.

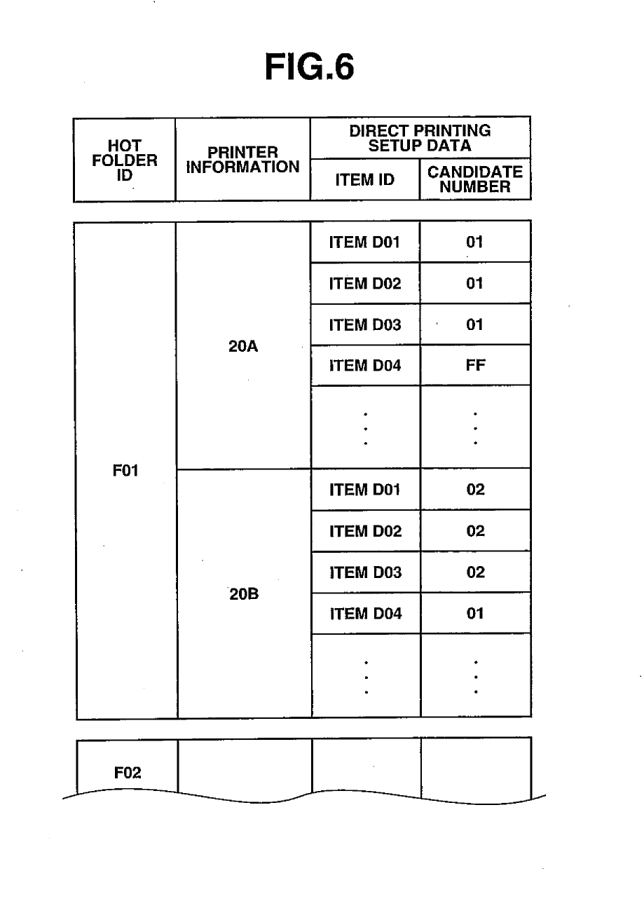

The direct printing setup data storage unit 51 stores in association with a hot folder and the like information of printer devices to which the direct printing unit 14 is capable of transmitting printing data and a combination of set values relating to the direct setting items (direct printing setup data) (see FIG. 6).

Since the operation of the other units 52 to 53 is the same as that of the prior art in principle, these operations are described in detail in an explanation of printing operation to be described later.

However, the printer driver unit 13 and the direct printing unit 14 of the present embodiment differ in configuration from the prior art with respect to being mutually linked to as to be able to use printing setup information with each other.

More specifically, as shown in FIG. 2C, the driver printing setup unit 30 of printer driver unit 13 differs from configurations of the prior art in that it is provided with a direct printing setup data acquisition unit 38, which acquires direct printing setup data created by the direct printing unit 14 by referring to the printing setup management information storage unit 50 and the direct printing setup data storage unit 51, and a direct printing linking preset setup unit 39, which extracts set values corresponding to the preset setting items from the acquired direct printing setup data to create preset printing setup data.

In addition, as shown in FIG. 2D, the direct printing unit 14 differs from configurations of the prior art in that it is provided with a preset printing setup data acquisition unit 54, which acquires preset printing setup data created by the printer driver unit 13 by referring to the printing setup management information storage unit 32 and the preset printing setup data storage unit 33, and a preset linking direct printing setup unit 55, which extracts set values corresponding to the direct setting items from the acquired preset printing setup data to create direct printing setup data.

Linking processing relating to printing setup of the printer driver unit 13 and the direct printing unit 14 based on each of the above-mentioned units is described in detail in an explanation of printing operation to be described later.

Furthermore, each unit is functionally realized as a result of the CPU executing a program contained in, for example, ROM, RAM or HDD within the host device 10 or an external storage medium.

(Printer Device)

The printer device 20 is provided with the same configuration as an ordinary printer device (see FIG. 1).

For example, the printer device 20 is provided with a power mechanism unit including, for example, a paper feed mechanism that feeds paper to the printer device, a printing engine that carries out printing, and a paper discharge mechanism that discharges paper from the printer device. The printing engine normally includes a paper transport mechanism, carriage mechanism, printing head, and various types of printing engines can be used corresponding to, for example, a serial printer, which prints in single character units in the manner of an ink jet printer or thermal transfer printer, a line printer, which prints in single line units, or a page printer, which prints in page units.

In addition, the printer device 20 is provided with, for example, an information processing unit including a CPU, ROM, RAM, communication interface and console panel or other user interface. The CPU of the printer device 20 is able to access each component through a bus, and for example, controls the power mechanism unit to as to actually carry out a printing operation based on printing data sent via the communication interface.

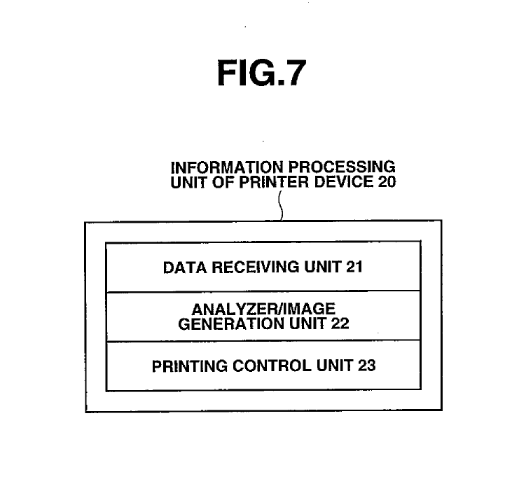

The function of the information processing unit of the printer device 20 is similar to the function of the information processing unit of a printer device of the prior art in principle. For example, the information processing unit of printer device 20 is provided with a data receiving unit 21 that receives printing data from the host device, an analyzer/image generation unit 22 that analyzes printing data, generates one band worth or one page worth of a printing image in a raster format, and then stores that printing image in an image buffer, and a printing control unit 23 that transfers a predetermined unit (such as one path worth) of a printing image to the printing engine from the image buffer and executes printing while controlling the printing engine (see FIG. 7).

Furthermore, each unit is functionally realized as a result of the CPU executing a program contained in, for example, ROM or RAM within the printer device 20 or an external storage medium.

(Printing Operation)

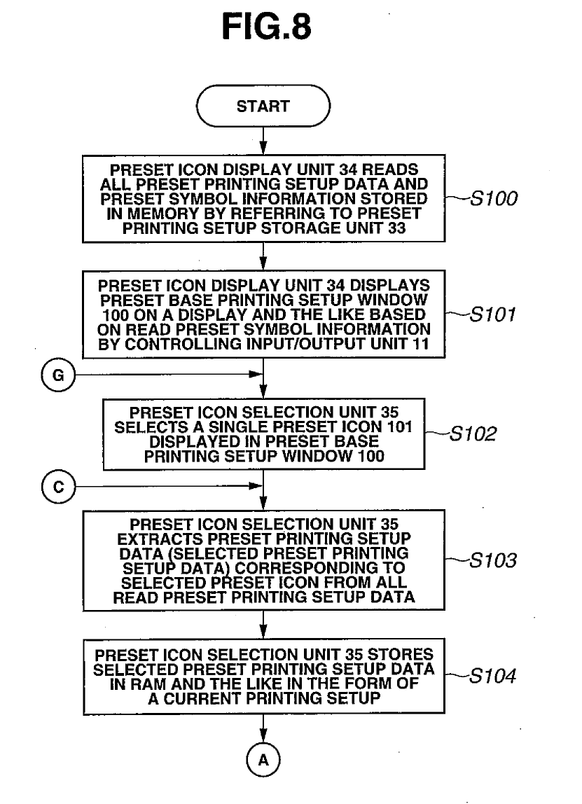

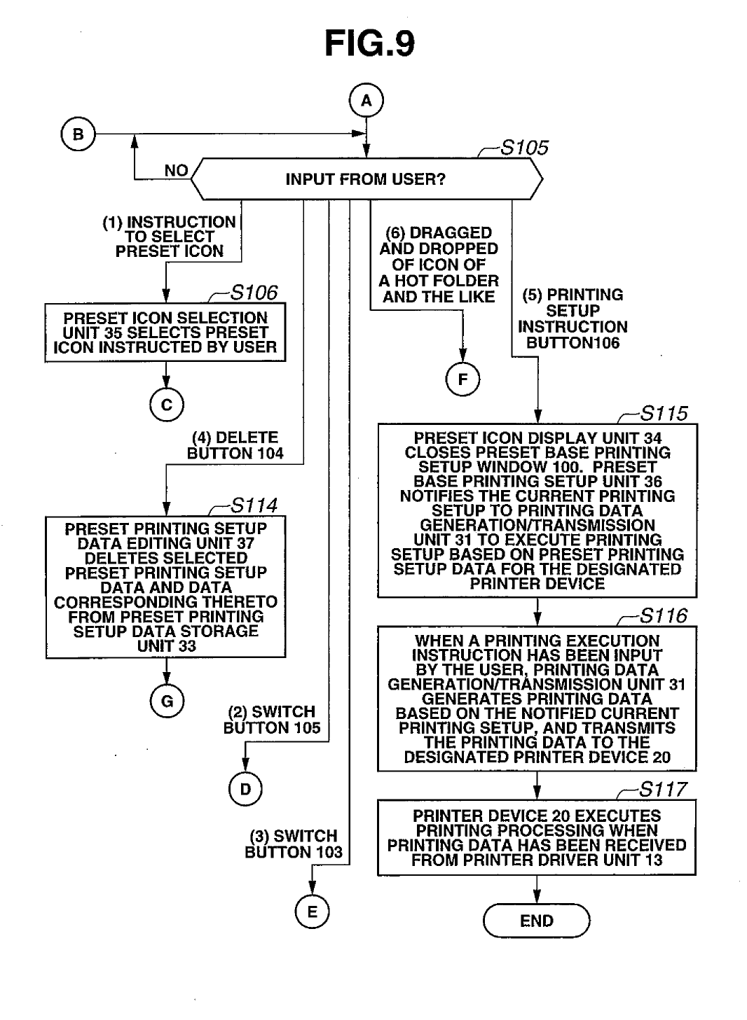

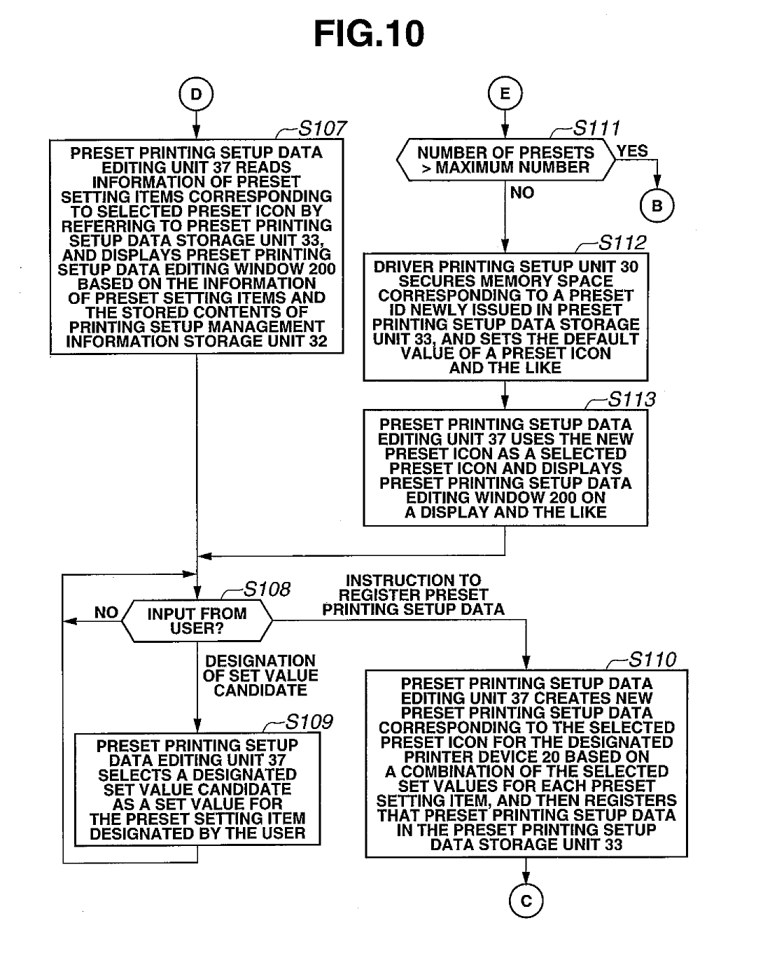

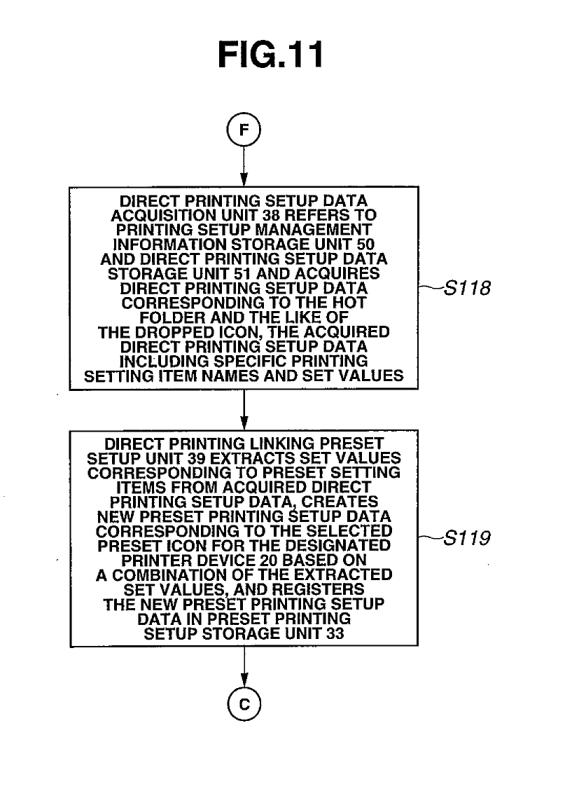

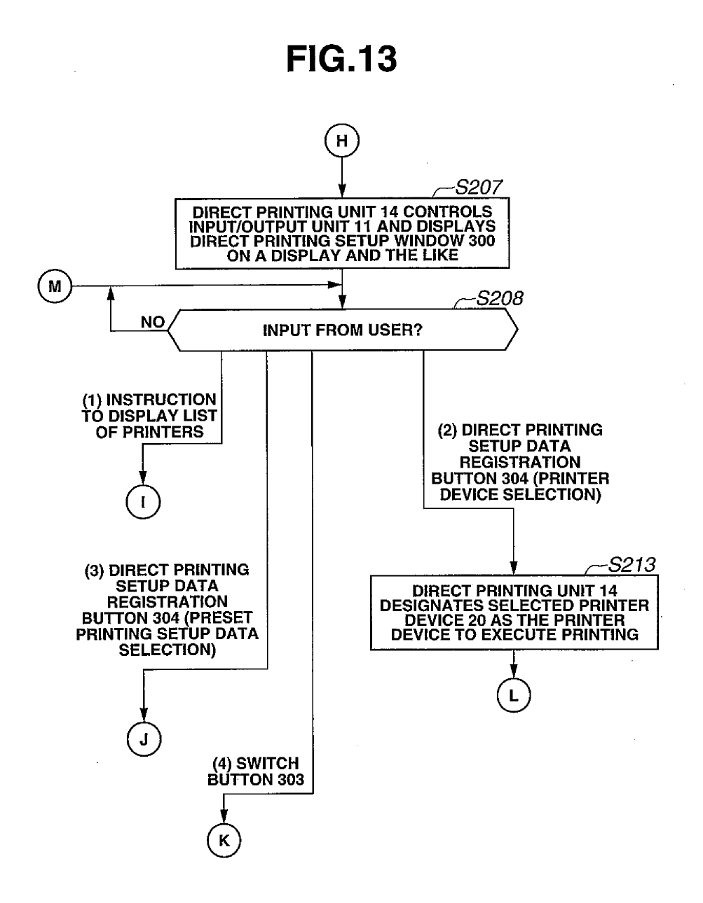

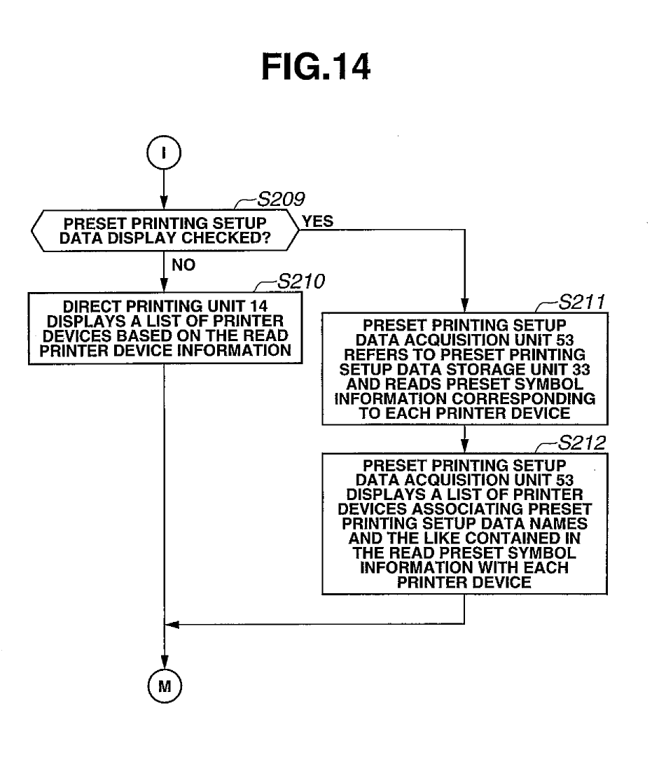

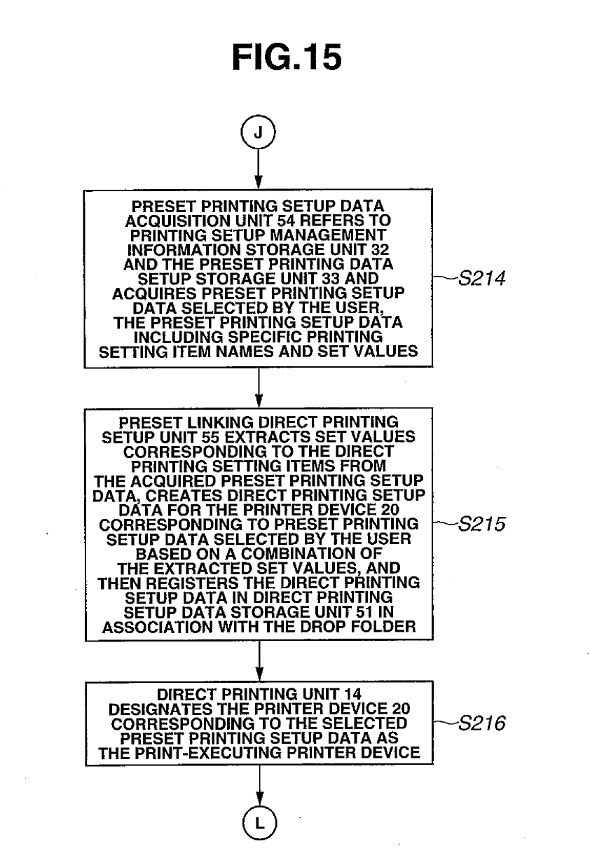

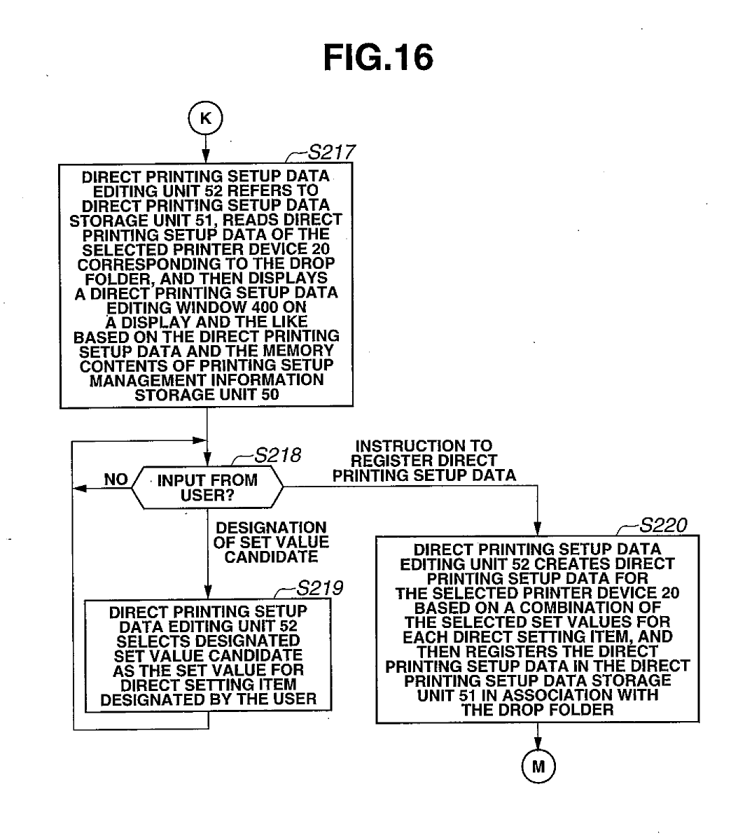

The following provides an explanation of the printing operation in the printer system 1 with reference to the flow charts shown in FIGS. 8 to 16. Furthermore, each step (including partial steps not indicated with reference symbols) can be executed while arbitrarily changing the order thereof or can be executed in parallel provided there is no contradiction with the contents of processing.

(Case of Printing Through Printer Driver Unit 13)

The printer driver unit 13 of the host device 10 executes the following processing when it receives a printing setup request designating either printer device 20A or 20B from an application program and the like running externally or on host device 10.

First, the preset icon display unit 34 reads all preset printing setup data and preset symbol information stored in memory relating to the designated printer device 20 by referring to the preset printing setup data storage unit 33 (S100).

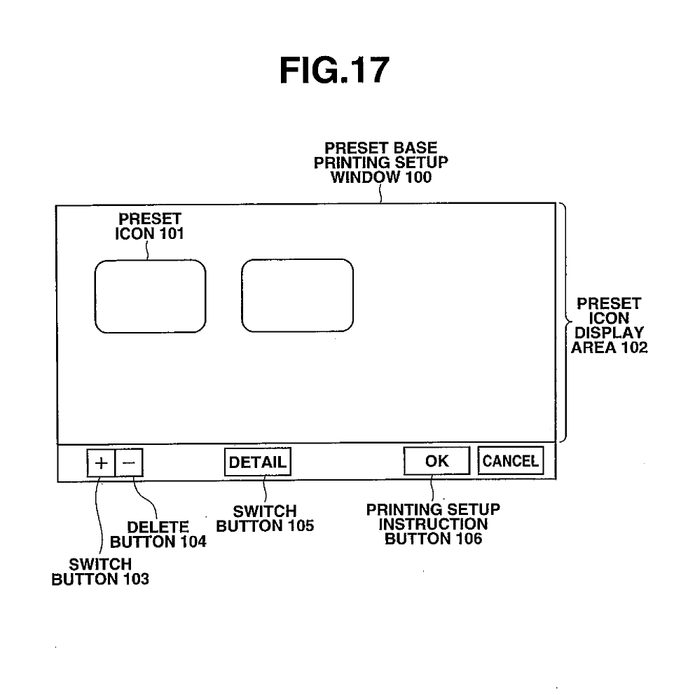

Next, the preset icon display unit 34 displays the preset base printing setup window 100 on a display and the like based on the read preset symbol information by controlling the input/output unit 11 (S101) (see FIG. 17).

As shown in FIG. 17, the preset base printing setup window 100 includes, for example, a preset icon display area 102, in which are arranged and displayed sets of icon and preset printing setup data name contained in the read preset symbol information (to be collectively referred to as a “preset icons”) 101, switch buttons 105 and 103 for switching to editing windows for existing preset printing setup data and new preset printing setup data, a delete button 104 for deleting existing preset printing setup data, and a printing setup instruction button 106.

Furthermore, in cases of a large number of preset icons that prevent all of the preset icons from being simultaneously displayed in the preset icon display area 102, a scroll bar and the like may be provided to display those preset icons.

Next, the preset icon selection unit 35 selects a single preset icon 101 displayed in the preset base printing setup window 100 (S102). Although selection criteria can be determined according to the design, criteria may be employed such as selecting preset icons on the basis of usage frequency or selecting preset icons selected during a previous execution of printing setup.

Next, the preset icon selection unit 35 extracts preset printing setup data (to be referred to as “selected preset printing setup data”) corresponding to the selected preset icon from all of the read preset printing setup data (S103), and then stores in RAM and the like in the form of a current printing setup (S104).

Next, the driver printing setup unit 30 waits for an input from a user (S105).

(1) In the case, for example, an instruction to select a preset icon has been received from the user such as by clicking with a mouse on a preset icon displayed in the preset icon display area 102, the preset icon selection unit 35 selects the instructed preset icon (S106) after which the program is controlled to return to S103.

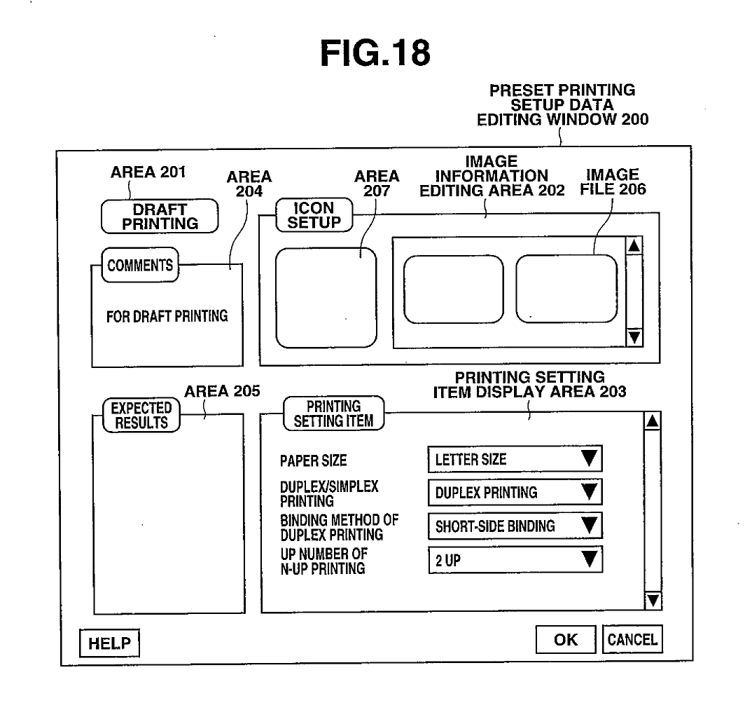

(2) In the case switch button 105 has been pressed by the user, the preset printing setup editing unit 37 reads information of preset setting items corresponding to the selected preset icon by referring to the preset printing setup data storage unit 33, and displays preset printing setup data editing window 200 on a display based on the read information of preset setting items and the stored contents of printing setup management information storage unit 32 (S107) (see FIG. 18).

As shown in FIG. 18, the preset printing setup data editing window 200 includes an area 201 for displaying name of the selected preset printing setup data, an area 202 for editing image information of the selected preset icon, a printing setting items display area 203, an area 204 for displaying comments relating to the selected preset printing setup data, and an area 205 for schematically displaying expected results in the case of carrying out printing based on selected set values.

The icon image editing area 202 is configured, for example, so as to set up an icon image by dragging and dropping an arbitrary image file 206 to a setup area 207. In addition, the printing setting display area 203 includes, for example, printing setting item names and a pull-down menu and the like allowing designation of set value candidates for each preset setting item.

Furthermore, the pull-down menu and the like preferably selects as default value a set value candidate that has been set in the selected preset printing setup data.

Next, the driver printing setup unit 30 waits for an input from the user (S108).

In the case a set value candidate has been designated by the user for a preset setting item, the preset printing setup data editing unit 37 selects the set value candidate as a set value for the preset setting item (S109), after which the program is controlled to return to S108.

In the case an instruction to register preset printing setup data has been input by the user, the preset printing setup data editing unit 37 creates new preset printing setup data corresponding to the selected preset icon for the designated printer device 20 based on a combination of the selected set value (or default value for that preset setting item not designated by the user) for each preset setting item, and then registers that preset printing setup data in the preset printing setup data storage unit 33 (S110). The program is then controlled to return to S103 after closing the preset printing setup data editing window 200.

Furthermore, a configuration is preferably employed such that, a check is made as to whether or not there is a conflict between set values selected for each preset setting item and in the case a conflict is present, the registration instruction input from the user is not accepted such as by displaying the registration instruction input button in gray. A conflict refers to, for example, designating cardboard for the type of paper and duplex printing even though duplex printing is unable to be performed for cardboard.

(3) In the case switch button 103 has been pressed by the user, the driver printing setup unit 30 checks whether the number of preset printing setup data elements exceeds the preset maximum number (S111), and if the maximum number is exceeded, displays a predetermined error message, for example, after which the program is controlled to return to S105.

On the other hand, if the maximum number is not exceeded, the driver printing setup unit 30 secures memory space corresponding to a preset ID newly issued in preset-printing setup data storage unit 33, and sets the default value of a preset icon and the like (S112). The preset printing setup data editing unit 37 uses the new preset icon as the selected preset icon and displays preset printing setup data editing window 200 on a display (S113) after which the program is controlled to proceed to S108.

(4) In the case the delete button 104 has been pressed by the user, the preset printing setup data editing unit 37 deletes the selected preset printing setup data and data corresponding thereto from the preset printing setup data storage unit 33 (S114) after which the program is controlled to return to S102.

(5) In the case the printing setup instruction button 106 has been pressed by the user, the preset icon display unit 34 closes the preset base printing setup window 100. In addition, the preset base printing setup unit 36 notifies the current printing setup stored in RAM to the printing data generation/transmission unit 31 to execute printing setup based on preset printing setup data relating to the designated printer device 20 (S115).

When printing setup has been executed and a printing execution instruction has been input by the user, the printing data generation/transmission unit 31 generates printing data based on the notified current printing setup, and transmits the printing data to the designated printer device 20 (S116). Printing data is composed to contain, for example, designated printing setup information and target printing data described by a printer control language. Furthermore, in the case the user has input a printing execution instruction without executing printing setup, printing data is generated by assuming that the default selection has been designated.

The printer device 20 executes printing processing when printing data has been received from the printer driver unit 13 (S117). For example, the printer device 20 analyzes printing data; generates one band worth or one page worth of the printing image in a raster format in accordance with the designations for printing resolution, the up number of N-up printing and the like, stores the generated printing image in an image buffer. In addition, a predetermined unit (such as one pass worth) of the generated printing image, for example, is transferred from the image buffer to the printing engine based on a control command contained in the printing data, after which the power mechanism unit is controlled so that printing is executed in a mode corresponding to designations such as the type of paper, number of printouts, paper size, designation of duplex or simplex printing and binding method of duplex printing.

(6) In the case an icon of a hot folder and the like is dragged and dropped to the preset base printing setup window 100 by the user, the direct printing setup data acquisition unit 38 refers to the printing setup management information storage unit 50 and the direct printing setup data storage unit 51 of the direct printing unit 14 and acquires direct printing setup data corresponding to the hot folder and the like of the dropped icon, the acquired direct printing setup data including specific printing setting item names and set values (S118). Furthermore, the dropping of an icon into window 100 can be notified by a message from the OS in the same manner as in the prior art.

Next, the direct printing linking preset setup unit 39 extracts set values corresponding to the preset setting items from the acquired direct printing setup data, creates new preset printing setup data corresponding to the selected preset icon for the designated printer device 20 based on a combination of the extracted set values (or default values with respect to preset setting items not corresponding to items contained in direct printing setup data), and registers the new preset printing setup data in the preset printing setup storage unit 33 (S119), after which the program is controlled to return to S103. Furthermore, it is possible to extract set values corresponding to the preset setting items from the direct printing setup data by extracting only set values of the direct setting items whose names are coincided with ones of the preset setting item names, for example.

(Case of Printing with Direct Printing Unit 14)

The direct printing unit 14 of host device 10 monitors a hot folder and the like, and executes the processing described below in the case a file has been dragged and dropped to the hot folder and the like by a user (the hot folder where the file has been dropped is to be referred to as “drop folder”).

Furthermore, the dropping of a file to a folder (folder icon) can be notified by monitoring the status of the folder contents. On the other hand, the dropping of a file to a file (file icon) can be notified by using an existing drop handler and the like.

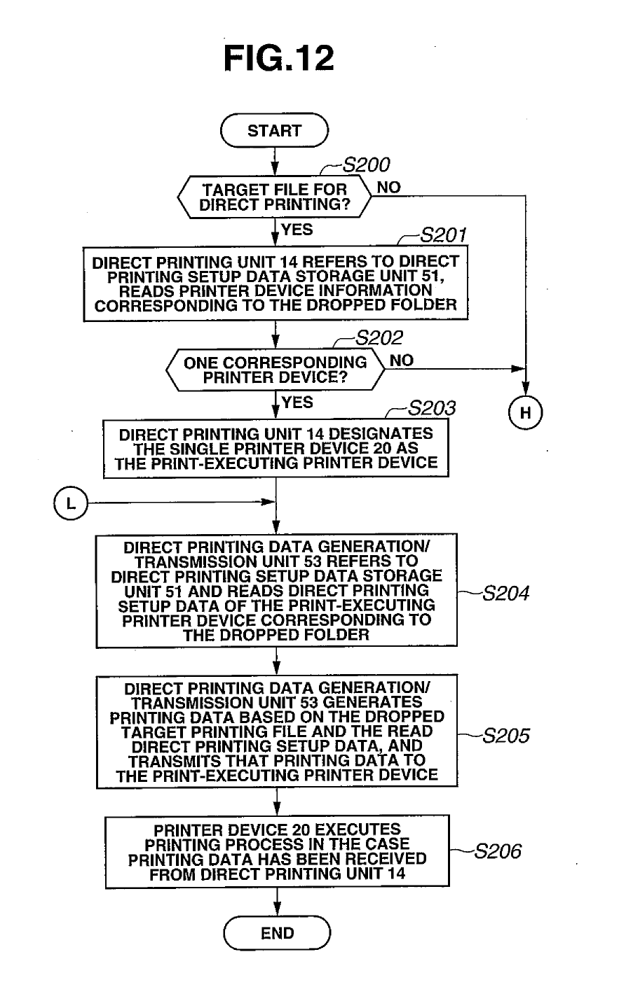

First, the direct printing unit 14 judges whether or not the file dropped to the drop folder is a target file for direct printing (such as a Postscript file, JPEG file, TIFF file or PDF file) (FIG. 12, S200).

In the case the dropped file is not a target file for direct printing, the direct printing unit 14 proceeds to S207.

On the other hand, in the case the dropped file is a target file for direct printing, the direct printing unit 14 refers to the direct printing setup data storage unit 51, reads printer device information corresponding to the drop folder (S201), and judges whether or not the number of corresponding printer devices 20 is one (S202).

In the case the number of printer devices 20 is one, the direct printing unit 14 designates that single printer device 20 as the print-executing printer device (S203).

Next, the direct printing data generation/transmission unit 53 refers to the direct printing setup data storage unit 51, reads the direct printing setup data of the print-executing printer device corresponding to the dropped folder (S204), generates printing data based on the dropped target printing file and the read direct printing setup data, and transmits that printing data to the print-executing printer device (S205).

Furthermore, in the case direct printing setup data has not been set for the print-executing printer device, printing data is generated by using the default set values of the print-executing printer device. In addition, generation of printing data based on, for example, a Postscript file, JPEG file, TIFF file or PDF file can be executed in the same manner as a direct printing tool of the prior art.

The printer device 20 executes printing process in the case printing data has been received from the direct printing unit 14 (S206). For example, the printer device 20 analyzes printing data, generates one band worth or one page worth of the printing image in a raster format in accordance with the designations for printing resolution and the like, stores the generated printing image in an image buffer. In addition, a predetermined unit (such as one pass worth) of the generated printing image, for example, is transferred from the image buffer to the printing engine based on a control command contained in the printing data, after which the power mechanism unit is controlled so that printing is executed in a mode corresponding to designations such as the type of paper, number of printouts, paper size, designation of duplex or simplex printing and binding method of duplex printing.

On the other hand, in the case the number of corresponding printer devices 20 is not one as a result of the judgment of S202, the direct printing unit 14 proceeds to S207.

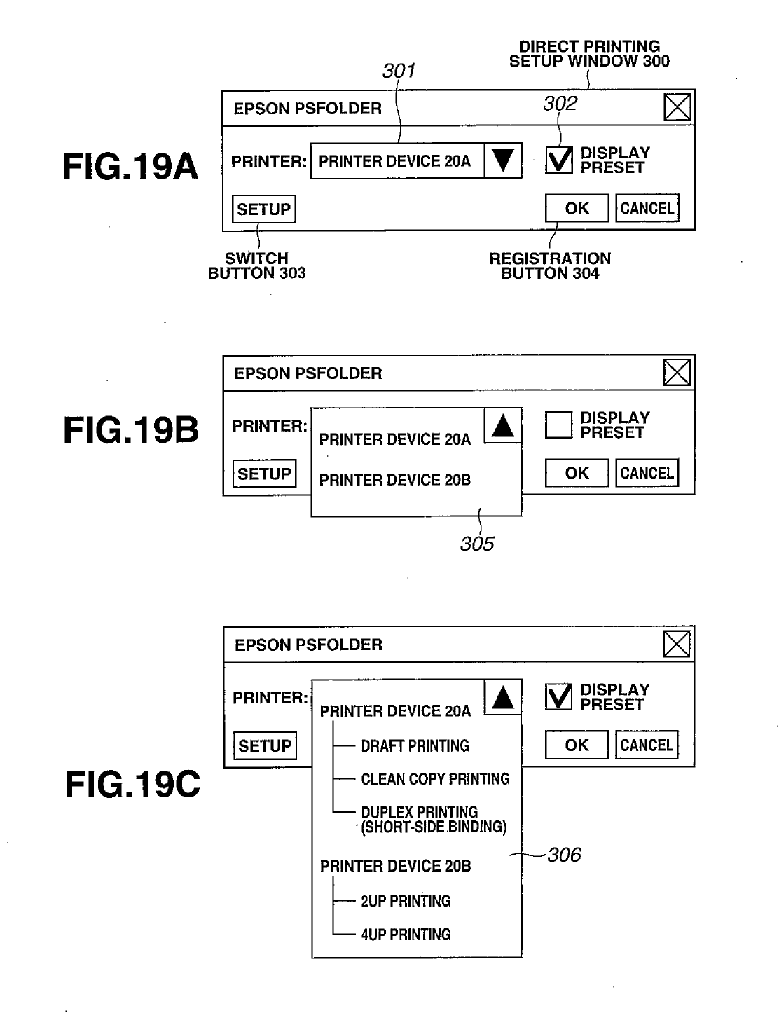

In S207, the direct printing unit 14 controls the input/output unit 11 and displays a direct printing setup window 300 on a display and the like (see FIG. 19A).

As shown in FIG. 19A, the direct printing setup window 300 includes, for example, a pull-down menu 301 allowing designation of the printer to execute direct printing, a check box 302 for designating whether or not preset printing setup data relating to the printer is to be displayed, a switch button 303 for switching to a direct printing setup data editing window, and a direct printing setup data registration button 304.

Furthermore, although the pull-down menu 301 is able to make setting item based on the read printer information, the printer device previously used to execute printing is preferably selected as a default value. In addition, a configuration may also be employed in which the registration button 304 is not provided and registration instructions are accepted when the direct printing setup window 300 has been closed.

Next, the direct printing unit 14 waits for an input from the user (S208).

(1) In the case an instruction to display a list of printers has been received from the user with the pull-down menu 301, the direct printing unit 14 judges whether or not the check box 302 has been checked (S209).

If it is not checked, the direct printing unit 14 displays a list of printer devices 305 based on the read printer device information (S210) and then returns to S208 (see FIG. 19B).

On the other hand, if checked, the preset printing setup data acquisition unit 53 refers to the preset printing setup data storage unit 33 and reads preset symbol information corresponding to each printer device (S211). It then displays a list of printer devices 306 associating preset printing setup data names and the like contained in the read preset symbol information with each printer device (S212) (see FIG. 19C), and then returns to S208. In the example shown in FIG. 19C, printer devices and the names of corresponding preset printing data are displayed by displaying the preset printing setup data names in the form of a treeview beneath the name of each printer device.

(2) In the case the direct printing setup data registration button 304 has been pressed by the user in the state in which a printer device 20 has been selected, the direct printing unit 14 designates the selected printer device 20 as the print-executing printer device (S213) and then proceeds to S204.

(3) In the case the direct printing setup data registration button 304 has been pressed by the user in the state in which the user has selected preset printing setup data by referring to a list of printer devices, the preset printing setup data acquisition unit 54 refers to the printing setup management information storage unit 32 and the preset printing data setup storage unit 33 and acquires the preset printing setup data selected by the user, the preset printing setup data including specific printing setting item names and set values (S214).

Next, the preset linking direct printing setup unit 55 extracts set values corresponding to the direct setting items from the acquired preset printing setup data, and creates direct printing setup data for the printer device 20 corresponding to the preset printing setup data selected by the user based on a combination of the extracted set values (or default values with respect to the direct setting items not corresponding to items contained in the preset printing setup data). The direct printing setup data is then registered in the direct printing setup data storage unit 51 in association with the drop folder (S215).

Furthermore, it is possible to extract set values corresponding to the direct setting items from the preset printing setup data by extracting only set values of the preset setting items whose names are coincided with ones of the direct setting item names, for example.

Next, the direct printing unit 14 designates the printer device 20 corresponding to the selected preset printing setup data as the print-executing printer device (S216) and then proceeds to S204.

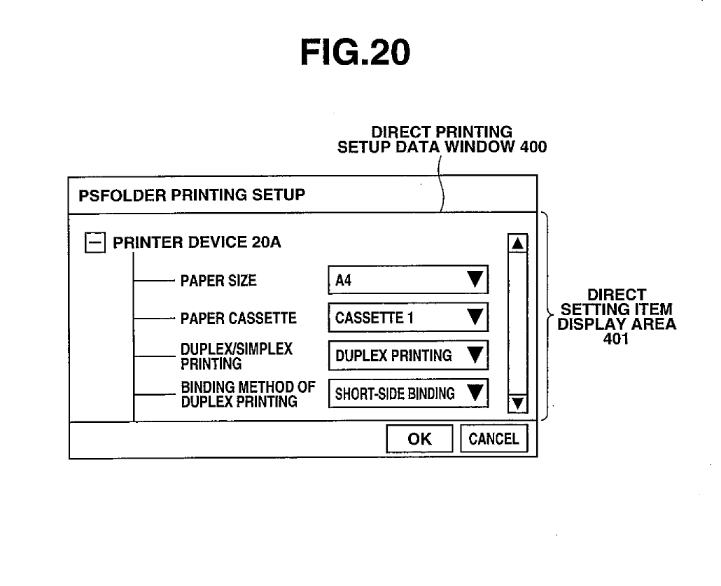

(4) In the case the switch button 303 has been pressed by the user in the state in which a printer device 20 has been selected, the direct printing setup data editing unit 52 refers to the direct printing setup data storage unit 51, reads direct printing setup data of the selected printer device 20 corresponding to the drop folder, and then displays a direct printing setup data editing window 400 on a display and the like based on the read direct printing setup data and the memory contents of the printing setup management information storage unit 50 (S217) (see FIG. 20).

As shown in FIG. 20, the direct printing setup data editing window 400 includes, for example, a direct setting display area 401, and this area 401 includes, for example, a pull-down menu allowing designation of printing setting item name and set value candidates for each direct setting item.

Furthermore, the pull-down menu and the like preferably selects as default value a set value candidate that has been set in the read direct printing setup data.

Next, the direct printing setup data editing unit 52 waits for an input from the user (S218).

In the case a set value candidate has been designated for a direct setting item by the user, the direct printing setup data editing unit 52 selects the designated set value candidate as the set value for that direct setting item (S219) and then proceeds to S218.

In the case an instruction to register direct printing setup data has been input by the user, the direct printing setup data editing unit 52 creates direct printing setup data for the selected printer device 20 based on a combination of the selected set values for each direct setting item (or set values in the read direct printing setup data with respect to the direct setting items not designated by the user), and then registers the direct printing setup data in the direct printing setup data storage unit 51 in association with the drop folder (S220). The program then returns to S208 after closing the direct printing setup data editing window 400.

Furthermore, a configuration is preferably employed such that, a check is made as to whether or not there is a conflict between set values selected for each direct setting item and in the case a conflict is present, the registration instruction input from the user is not accepted such as by displaying the registration instruction input button in gray.

In this manner, in the present embodiment, the printer driver unit 13 is configured such that preset printing setup data can be registered by referring to direct printing setup data managed by the direct printing unit 14, while the direct printing unit 14 is configured such that direct printing setup data can be registered by referring to preset printing setup data managed by the printer driver unit 13. According to this configuration, a scheme is realized that allows printing setup information to be mutually used between the direct printing function that carries out printing without the printer driver and the preset printing function that carries out printing through the printer driver, thereby making it possible to greatly improve user convenience with respect to printing setup.

(Variation)

The invention is not limited to the above embodiment, but may be modified in various ways.

For example, although registration of preset printing setup data is carried out on the basis of direct printing setup data in the case an icon of a hot folder and the like is dragged and dropped to the preset base printing setup window 100 in the above-mentioned embodiment, a configuration may also be employed in which registration of preset printing setup data is carried out on the basis of direct printing setup data in the case another operation is done as a trigger thereof, such as an icon of a hot folder and the like is dropped to a window other than the window 100.

In addition, although a configuration is employed in the above-mentioned embodiment in which a printer device 20 executes processing such as interpretation of printing data or generation of a printing image, a configuration may also be employed in which a portion or all of that processing is executed by the host device 10 (the printer driver unit 13 or the direct printing unit 14).

What is claimed is:

1. An information processing device provided with a direct printing function that causes a printer device to execute printing without a printer driver, comprising:
a setup storage unit that stores a combination of set values (hereinafter, “direct printing setup data”) relating to a plurality of printing setting item (hereinafter, “direct setting items”) in association with a specific folder or file (hereinafter “hot folder, or the like”);
a setup registration unit that creates direct printing setup data based on a hot folder or the like selected by a user and registers that direct printing setup data in the setup storage unit; and
a unit that generates, when a printing target file has been dragged and dropped to a hot folder or the like, printing data based on the printing target file and the direct printing setup data associated with the hot folder or the like, and transmits the generated printing data to the predetermined printing device, wherein
the setup registration unit includes:
an acquisition unit that acquires a combination of set values relating to a plurality of printing setting items created by the printer driver (hereinafter, “preset printing setup data”); and
a unit that extracts set values corresponding to the direct setting items from the acquired preset printing setup data to create direct printing setup data.

2. The information processing device according to claim 1, wherein the acquisition unit displays the name or the like of preset printing setup data corresponding to the printer device for each printer device to which the information processing device is capable of transmitting printing data, and acquires preset printing setup data selected by a user who refers to the display.

3. A printer driver provided with a preset printing setup function for pre-registering a combination of set values (hereinafter “preset printing setup data”) relating to a plurality of printing setting items (hereinafter “preset setting items”), and carrying out printing setup en bloc for the plurality of printing setting items based on the preset printing setup data, comprising:
a preset storage unit that stores the preset printing setup data in association with a preset symbol for selecting the preset printing setup data, and
a preset registration unit that creates the preset printing setup data for a predetermined preset symbol and registers that preset printing setup data in the preset storage unit, wherein
the preset registration unit includes:
an acquisition unit that acquires a combination of set values relating to a plurality of printing setting items (hereinafter “direct printing setup data”) created by an information processing device that causes the printer device to execute printing without a printer driver; and
a unit that extracts set values corresponding to the preset setting items from the acquired direct printing setup data to create preset printing setup data.

4. The printer driver according to claim 3, wherein the acquisition unit acquires the direct printing setup data stored by the information processing device in association with a specific folder or file in the case an icon of the specific folder or file has been dragged and dropped to a predetermined window.

5. A direct printing method that causes printing to be executed
on a printer device without a printer driver,
the method comprising:
creating a combination of set values (hereinafter “direct printing setup data”) relating to a plurality of printing setting items (hereinafter “direct setting items”), and storing the direct printing setup data in association with a specific folder or file (hereinafter “hot folder or the like”) selected by a user; and
generating, when a printing target file has been dragged and dropped to a hot folder or the like, printing data based on the dropped printed target file and the direct printing setup data associated with the hot folder, and transmitting the generated printing data to the predetermined printing device, wherein
the setup registration includes:
acquiring a combination of preset values relating to relating to a plurality of printing setting items created by the printer driver (hereinafter “preset printing setup data”); and
extracting set values corresponding to the direct setting items from the acquired preset printing setup data to create direct printing setup data.

6. A preset printing setup method utilizing a printer driver, the method comprising:
creating, by the printer driver, a combination of set values (hereinafter “preset printing setup data”) relating to a plurality of printing setting items (hereinafter “preset setting items”) and storing the preset printing setup data in a storage unit; and
carrying out, by the printer driver, printing setup en bloc for the plurality of preset setting items based on the preset printing setup data, wherein
the creating step includes:
acquiring, by the printer driver, a combination of set values relating to a plurality of printing setting items (hereinafter “direct printing setup data”) created by an information processing device that causes a printer device to execute printing without the printer driver, and
extracting, by the printer driver, set values corresponding to the preset setting items from the acquired direct printing setup data to create preset printing setup data.

7. A program for executing the direct printing method according to claim 5 on a computer.

8. A program for executing the preset printing setup method according to claim 6 on a computer.
